(19) United States
(12) Patent Application Publication
(10) Pub. No.: US 2015/0076789 A1
(43) Pub. Date: Mar. 19, 2015

(54) BICYCLE INLAY

(71) Applicant: D6 Sports, Inc., Huntington Beach, CA (US)

(72) Inventors: Amit Singh, Coto de Caza, CA (US); Robert Charles Kahler, JR., Irvine, CA (US)

(21) Appl. No.: 14/491,766

(22) Filed: Sep. 19, 2014

Related U.S. Application Data
(60) Provisional application No. 61/880,102, filed on Sep. 19, 2013.

(51) Int. Cl. B62K 3/08

(52) U.S. Cl. CPC B62K 3/08
USPC 280/281.1; 29/897.2; 428/535; 428/542.2

(57) ABSTRACT

A bicycle includes a frame that has upper tubes spaced apart from each other; and an inlay spaced between the upper tubes. The frame of the bicycle may further include a pair of tubes spaced apart by the upper tubes. The inlay may extend between the pair of tubes. The inlay may be comprised of wood.

### CROSS REFERENCE TO RELATED APPLICATIONS

This application claims the benefit of U.S. Provisional Application No. 61/880,102 filed Sep. 19, 2013, which is incorporated herein by reference in its entirety.

### FIELD OF THE INVENTION

The present invention relates to a tubular structure, and more particularly to an inlay for a bicycle and a kit for providing inlays for a bicycle.

### BACKGROUND OF THE INVENTION

Bicycles are popular transportation tools and their frames are subject to constant stress, strain and shocks.

### SUMMARY OF THE PREFERRED EMBODIMENTS

In accordance with a first aspect of the present invention there is provided a bicycle with a frame, the frame having upper tubes spaced apart from each other and an inlay spaced between the upper tubes.

In accordance with another aspect of the present invention there is provided an inlay for a bicycle, the inlay including a board having a thickness, wherein the board is comprised of a material that is light weight, and the board is affixed within a space provided by elements of the frame.

In accordance with yet another aspect of the present invention there is provided a method for manufacturing a bicycle, the method including the steps of providing a frame having upper tubes, providing a cross bar between the upper tubes, and attaching an inlay to the cross bar.

In accordance with still yet another aspect of the present invention there is provided a kit that provides at least 2 inlays for attachment onto a bicycle.

The invention, together with additional features and advantages thereof, may be best understood by reference to the following description.

### BRIEF DESCRIPTION OF THE DRAWINGS

FIG. 1a is a side view of an exemplary embodiment of a bicycle having an inlay;

FIG. 1b is a side view of another exemplary embodiment of a bicycle having an inlay;

FIG. 2a is a perspective view of the inlay and the frame of the bicycle of FIG. 1a; and

FIG. 2b is a perspective view of the inlay and the frame of the bicycle of FIG. 1b.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an other embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” and “below” used herein are merely for ease of description and refer to the orientation of the components as shown in the figures. It should be understood that any orientation of the components described herein is within the scope of the present invention.

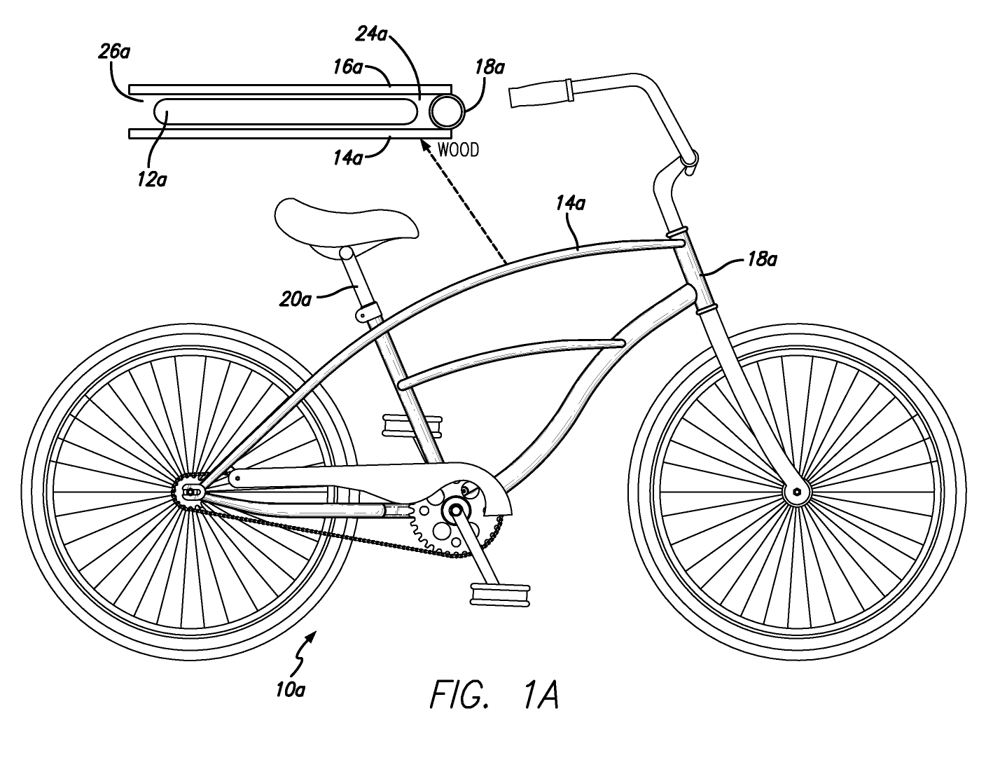

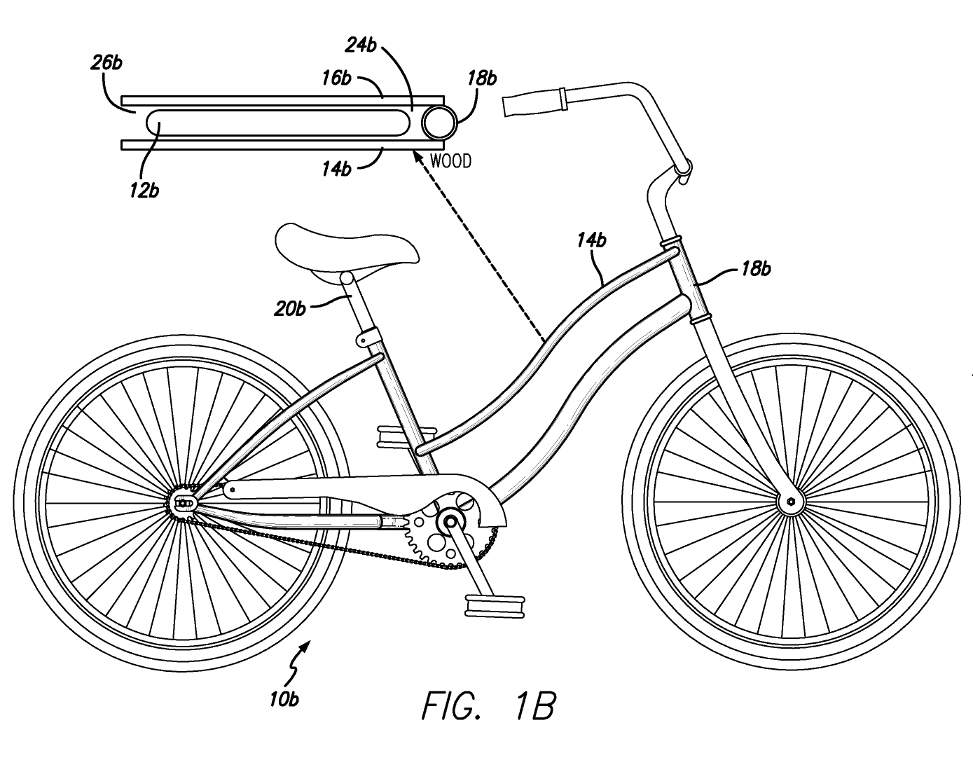

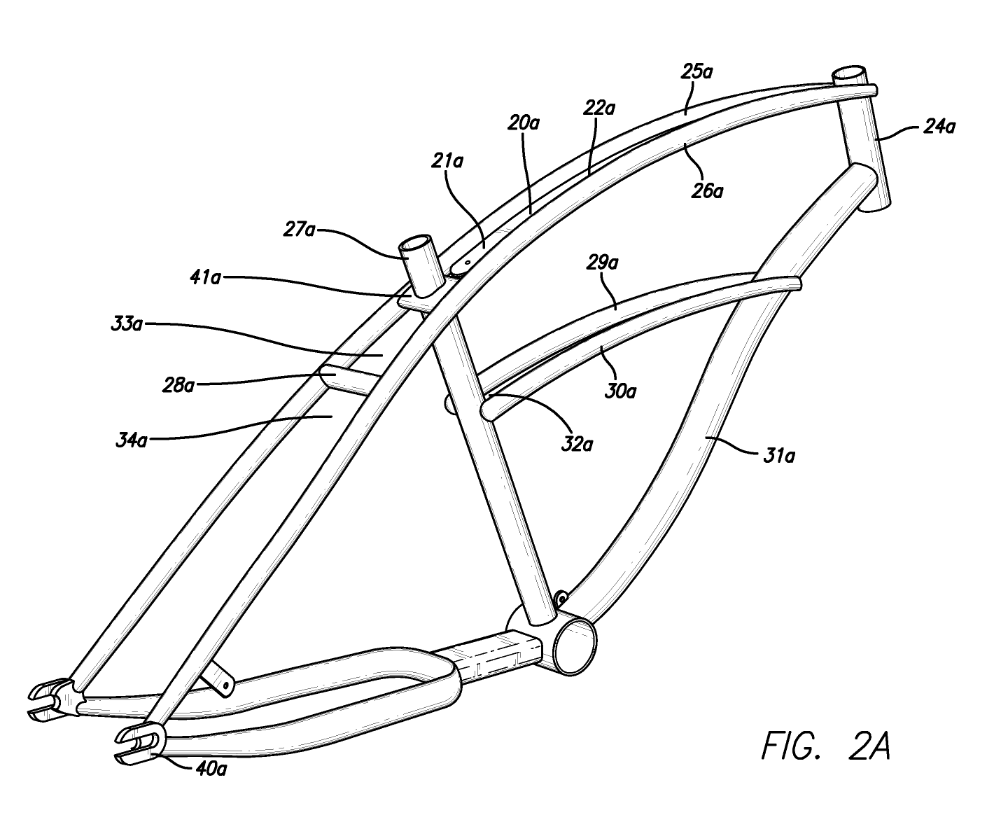

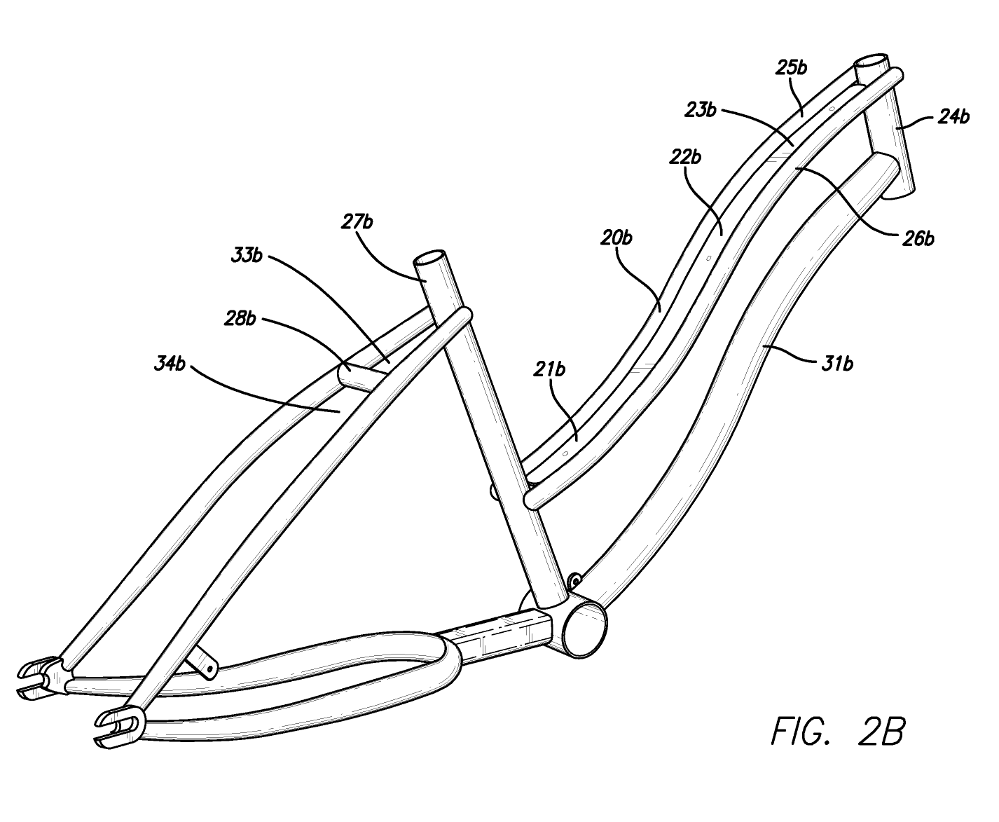

Referring now to the drawings, wherein the drawings are for purposes of illustrating the present invention and not for purposes of limiting the same, FIGS. 1a-2b show a bicycle with an inlay spaced between elements of the bicycle frame.

In a preferred embodiment, as shown in FIG. 1a, an exemplary ladies' bicycle 10a has a frame, which includes a first top tube 14a and a second top tube 16a. As first top tube 14a and second top tube 16a have identical shapes and length, the side view of FIG. la only shows one of the two top tubes, i.e., first top tube 14a. Inlay 12a is placed between first top tube 14a and second top tube 16a spaced apart, and extends from forward section 24a towards head tube 18a to rear section 26a towards seat tube 20a. Inlay 12a may extend the full length of, or only a portion of the length of the elongated space between first top tube 14a and second top tube 16a.

In a preferred embodiment, as shown in FIG. 1b, another exemplary men's bicycle 10b has a frame, which includes a first top tube 14b and a second top tube 16b. As first top tube 14b and second top tube 16b have identical shapes and length, the side view of FIG. lb only shows one of the two top tubes, i.e., first top tube 14b. Inlay 12b is placed between first top tube 14b and second top tube 16b spaced apart, and extends from section 24b towards head tube 18b to rear section 26b towards seat tube 20b. Inlay 12b may extend the full length of, or only a portion of the length of the elongated space between first top tube 14b and second top tube 16b.

FIG. 2a further illustrates inlay 12a of FIG. 1a as inlay 20a in the context of the frame structure of bicycle 10a. In this preferred embodiment, head tube 24a is coupled to a first top tube 25a and a second top tube 26a, both of which extend downwards past seat tube 27a and further towards the fork 40a for mounting a rear wheel (not shown). Seat tube 27a is coupled to both first top tube 25a and second top tube 26a via a seat tube gusset 41a. There may be a crossbar 28a connecting the portion of first top tube 25a and second top tube 26a that extend past seat tube 27a. Seat tube 27a extends downwards and is coupled to a lower tube 31a. Lower tube 3 la is connected to head tube 24a at the opposite end where it is connected to seat tube 27a. Underneath first top tube 25a and second top tube 26a, the frame may include a first cantilever tube 29a and a second cantilever tube 30a, both of which are connected to seat tube 27a at one end and to lower tube 31a at the other end.

In a preferred embodiment, inlay 20a has a rear section 21a and a forward section 22a. Inlay 20a may be affixed between the space provided by first top tube 25a and second top tube 26a by having rear section 21a screwed onto a cross member (not shown) that may be welded between and onto first top tube 25a and second top tube 26a. The cross member may also be provided in other structures that connect first top tube 25a and second top tube 26a. Rear section 21a may also be affixed between the space provided by first top tube 25 and second top tube 26a via welding or glue. Forward section 22a may be affixed between the space provided by first top tube 25 and second top tube 26a via friction fitting or gluing. Inlay 20a may be removable and interchangeable with other inlays.

In a preferred embodiment, inlay 20a may include a length, a width and a thickness.

Preferably, inlay 20a has a length of from about 20″ to about 24″, a width from about to about ¾″ to about 1¼″, and a thickness of from about ⅛″ to about 1/4″. More preferably inlay 20a has a length of about 22″, a width of about 1″ and a thickness of about ⅙″. Optimally, inlay 20a for bicycle 10a has a length of 23½″, a width of 1¼″ and a thickness of ¼″.

In a preferred embodiment, inlay 20a may include a thickness that is less that the diameters of first top tube 25a and second top tube 26a. In yet another preferred embodiment, inlay 20a may include a thickness that is not limited by the diameter of first and second top tubes. For example, inlay 20a may extend around and cover first top tube 25a and second top tube 26a. Inlay 20a may be affixed to space provided by the frame of bicycle 10a other than the illustrated space between first top tube 25a and second top tube 26a. More than one inlay may be affixed between one space provided by the frame of bicycle 10a, more than one inlay may be affixed between more than one space provided by the frame of bicycle 10a.

In a preferred embodiment, inlay 20a may display a color, multiple colors, or designs, logos and mixtures thereof. For example, inlay 20a may be blue, yellow and pink. Inlay 20 may be comprised of a material that is light weight and capable of being bent. Preferably, the weight of inlay 20a may be from about 1.5 oz. to about 3.5 oz. More preferably, the weight of inlay 20a may be about from 2.0 oz. to about 3.0 oz. Optimally, the weight of inlay 20a may be about 2.5 oz. Such materials may include wood, fiberglass, metal, cardboard, plastic, composite, and/or mixtures thereof. Inlay 20a may also include electronic components such as LEDs, flash lights, and batteries. Inlay 20a may also be capable of displaying messages and images via electronic components.

FIG. 2b further illustrates inlay 12b of FIG. 1b as inlay 20b in the context of the frame structure of bicycle 10b. In this preferred embodiment, head tube 24b is coupled to a first top tube 25b and a second top tube 26b, which extend downwards and is connected to seat tube 27b. There may be a crossbar 28b connecting two tubes that coupled to the a lower tube 31b. Lower tube 31b is connected to the head tube 24b at the opposite end where it is connected to the seat tube 27b.

In a preferred embodiment, inlay 20b has a rear section 23b, a middle section 22b and a forward section 23b. Inlay 20b may be affixed between the space provided by first top tube 25b and second top tube 26b by having rear section 21b, middle section 22b and forward section 23b screwed onto cross members (not shown) that may be welded between and onto first top tube 25b and second top tube 26b. The cross members may also be provided in other structures that connect first top tube 25b and second top tube 26b. Rear section 21b may also be affixed between the space provided by first top tube 25b and second top tube 26b via welding or glue. Inlay 20b may be removable and interchangeable with other inlays.

In a preferred embodiment, inlay 20b may include a length, a width and a thickness. Preferably, inlay 20b has a length of from about 20″ to about 24″, a width from about to about ¾″ to about 1¼″, and a thickness of from about ⅛″ to about ¼″. More preferably inlay 20b has a length of about 22″, a width of about 1″ and a thickness of about ⅙″. Optimally, inlay 20b for bicycle 10b has a length of 22½″, a width of 1¼″ and a thickness of ¼″.

In a preferred embodiment, inlay 20b may include a thickness that is less that the diameters of first top tube 25b and second top tube 26b. In yet another preferred embodiment, inlay 20b may include a thickness that is not limited by the diameter of first and second top tubes. For example, inlay 20b may extend around and cover first top tube 25b and second top tube 26b. Inlay 20b may be affixed to space provided by the frame of bicycle 10b other than the illustrated space between first top tube 25b and second top tube 26b. More than one inlay may be affixed between one space provided by the frame of bicycle 10b, more than one inlay may be affixed between more than one space provided by the frame of bicycle 10b. For example, an inlay may be placed in other spaces provided by the bicycle frame, i.e., space 33b and 34b as shown in FIG. 2b.

In a preferred embodiment, inlay 20b may display a color, multiple colors, or designs, logos and mixtures thereof. For example, inlay 20b may be blue, yellow and pink. Inlay 20b may be comprised of a material that is light weight and capable of being bent. Preferably, the weight of inlay 20b may be from about 1.5 oz. to about 3.5 oz. More preferably, the weight of inlay 20b may be about from 2.0 oz. to about 3.0 oz. Optimally, the weight of inlay 20b may be about 2.5 oz. Such materials may include wood, fiberglass, metal, plastic, cardboard, composite, and/or mixtures thereof. Inlay 20b may also include electronic components such as LEDs, flash lights, and batteries. Inlay 20b may also be capable of displaying messages and images via electronic components.

In another preferred embodiment, a method may be provided for manufacturing a bicycle. The method may include the steps of providing a frame having top tubes, providing a cross bar between the top tubes, and attaching an inlay to the cross bar. The method may also include the step of attaching an inlay to the cross bar by screws.

In yet another preferred embodiment, a kit including at least 2 inlays may be provided for a cyclist to attach the inlay to a bicycle, or to replace or interchange the inlay already attached to a bicycle with the ones provided in the kit. The kit may further include devices, apparatus and instructions for attaching inlays included in the kit onto a bicycle according to the illustration and description of FIGS. 2a and 2b.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed, at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. § 112, ¶6 will begin with the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A bicycle with a frame, the bicycle comprising one or more inlays between one or more spaces provided by elements of the frame, wherein the inlay comprises a board having a thickness, wherein the board is comprised of a material that is light weight, and the board is affixed in a space provided by elements of the frame.

2. A bicycle, the bicycle comprising:
a frame, the frame having upper tubes spaced apart from each other; and
an inlay positioned between the upper tubes.

3. The bicycle according to claim 2, wherein the inlay extends between the pair of tubes.

4. The bicycle according to claim 2, wherein the inlay is comprised of wood.

5. The bicycle according to claim 2, wherein the inlay has a length, width and thickness, and wherein the length ranges from about 20 inches to about 24 inches, the width from about ¾ inch to about 1 and ¼ inches and the thickness from about ⅛ inch to ¼ inch.

6. The bicycle according to claim 2, wherein the inlay is ornamentalized.

7. A method for manufacturing a bicycle, the method comprising the steps of:
providing a frame having upper tubes;
providing a cross bar between the upper tubes; and
attaching an inlay to the cross bar.

8. The method of claim 7, wherein the inlay is attached by screws.

9. The method of claim 7, wherein the inlay is comprised of wood.

10. An inlay for a bicycle having a frame, the inlay comprising a board having a thickness, wherein the board is comprised of a material that is light weight, and the board is affixed in a space provided by elements of the frame.

11. The inlay of claim 10, wherein the board extends the full length of the space provided by the elements of the frame.

12. The inlay of claim 10, wherein the board extends between the space provided by the elements of the frame.

13. The inlay of claim 10, wherein the board is of a shape that is adapted to a shape of the space provided by the elements of the frame.

14. The inlay of claim 10, wherein the material is selected from the group consisting of wood, fiberglass, polymer, composite, cardboard and mixtures thereof

15. The inlay of claim 10, wherein the board is an integral piece.

16. The inlay of claim 10, wherein the board is comprised of at least two pieces.

17. The inlay of claim 10 further comprising at least one electronic component.

18. The inlay of claim 10, wherein the inlay is removable from the bicycle.

19. A kit for a bicycle with a frame, the kit comprising at least 2 inlays for the bicycle, wherein the inlay comprises a board having a thickness, wherein the board is comprised of a material that is light weighted, and the board is affixed to a space provided by elements of the frame.

20. The kit of claim 19 further comprising means to affix the inlays to space provided by elements of the frame.

21. The kit of claim 19 further comprising instructions on how to affix the inlays to space provided by elements of the frame.
